(19) United States
(12) Patent Application Publication
(10) Pub. No.: US 2016/0211619 A1
(43) Pub. Date: Jul. 21, 2016

(54) ELECTROSTATIC DISCHARGE FOR ELECTRONIC DEVICE COUPLING

(71) Applicant: Intel Corporation, Santa Clara, CA (US)

(72) Inventors: Jackson Chung Peng Kong, Tanjung Tokong (MY); Bok Eng Cheah, Gelugor (MY); Howard L Heck, Hillsboro, OR (US); Kuan-Yu Chen, Hillsboro, OR (US); Boon Ping Koh, Seberang Jaya (MY); Min Keen Tang, Taman Sri Nibong (MY); Kooi Chi Ooi, Glugor (MY)

(73) Assignee: Intel Corporation, Santa Clara, CA (US)

(21) Appl. No.: 14/601,403

(22) Filed: Jan. 21, 2015

(51) Int. Cl. H01R 13/648; H01R 24/66

(52) U.S. Cl. CPC H01R 13/6485; H01R 24/66; H01R 2107/00

(57) ABSTRACT

In one example an electronic device comprises a housing. A receptacle in the housing comprising an opening at a distal end to receive a plug and an electrostatic conductor assembly positioned proximate the opening in the receptacle, wherein the electrostatic conductor assembly is coupled to a dedicated electrical discharge path. Other examples may be described.

### RELATED APPLICATIONS

None.

### BACKGROUND

The subject matter described herein relates generally to the field of electronic devices and more particularly to an electrostatic discharge for electronic device coupling.

Electronic devices may be coupled to remote devices by a data connectors such as a universal serial bus (USB) connector, audiovisual (AV) connectors or Ethernet connectors. Static electricity may build up on the connector plug and, if discharged through a data connector, may present a risk to the electronic circuitry in the devices. Accordingly, electrostatic discharge techniques for electronic device couplings may find utility.

### BRIEF DESCRIPTION OF THE DRAWINGS

The detailed description is described with reference to the accompanying figures.

FIG. 1 is a schematic illustration of an electronic device which may be adapted to implement electrostatic discharge in accordance with some examples.

FIG. 2 is a perspective view of a schematic illustration of a connector for an electronic device adapted to implement electrostatic discharge in accordance with some examples.

FIGS. 3A-3C are side views of a schematic illustration of a connector for an electronic device adapted to implement electrostatic discharge in accordance with some examples.

FIGS. 4-5 are side views schematic illustrations of examples of a connector for an electronic device adapted to implement electrostatic discharge in accordance with some examples.

FIGS. 6-10 are schematic illustrations of electronic devices which may be adapted to implement electrostatic discharge in accordance with some examples.

### DETAILED DESCRIPTION

Described herein are exemplary systems and methods to implement electrostatic discharge in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide techniques for electrostatic discharge in electrical connectors which may be used to couple components of an electronic device to an external device. For example, it may be useful to provide for electrostatic discharge in data connectors such as universal serial bus (USB) connectors, audiovisual (AV) connectors or Ethernet connectors such that electrostatic charges may be dissipated through an electrical discharge path that is removed from data pins on the connectors.

To address this issue, in some examples an electrical connector is provided with a receptacle comprising an opening at a distal end to receive a plug and an electrostatic conductor assembly positioned proximate the opening in the receptacle, wherein the electrostatic conductor assembly is coupled to a dedicated electrical discharge path. In further examples the electrical connector may be coupled to an input/output (I/O) interface of a component, which may be incorporated into an electronic device.

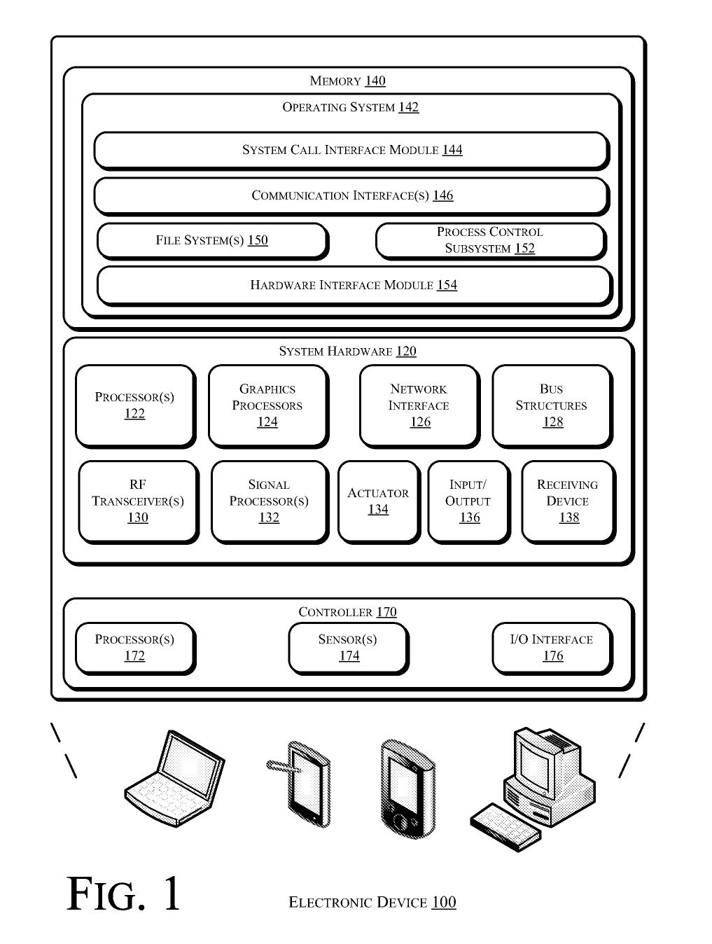

Additional features and operating characteristics of the electronic device and associated system are described below with reference to FIGS. 1-10.

FIG. 1 is a schematic illustration of an electronic device which may be adapted to implement electrostatic discharge in accordance with some examples. In various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 120. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more actuators 134 and one or more input/output interfaces 136 such as, e.g., a keypad and/or a display. In some examples electronic device 100 may not have a keypad and use the touch panel for input.

Electronic device 100 may further include at least one wireless power receiving device 138 to receive power via an electromagnetic coupling with a driven coil in a charging device. The wireless power receiving device 138 may comprise one or more coil(s) to receive power through an inductive coupling with a driven coil or coupling charge plate(s) to receive power through a capacitive coupling with a driven capacitor in the charging device.

Memory 140 may include an operating system 142 for managing operations of electronic device 100. In one embodiment, operating system 142 includes a hardware interface module 154 that provides an interface to system hardware 120. In addition, operating system 142 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 140. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms. In the embodiment depicted in FIG. 1 the controller 170 comprises a processor 172, a sensor 174, and an I/O interface 176.

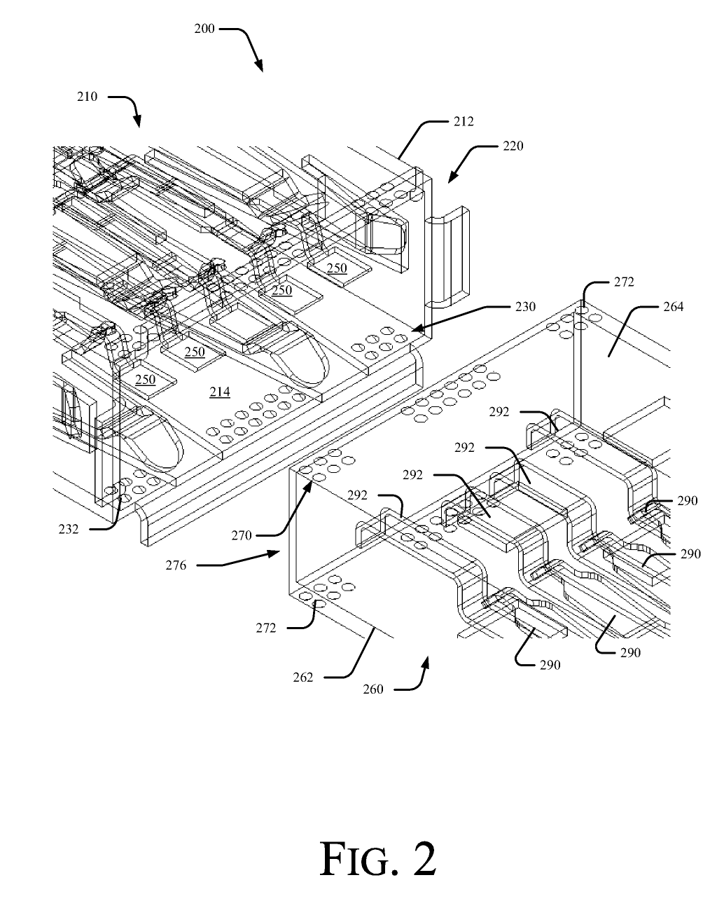

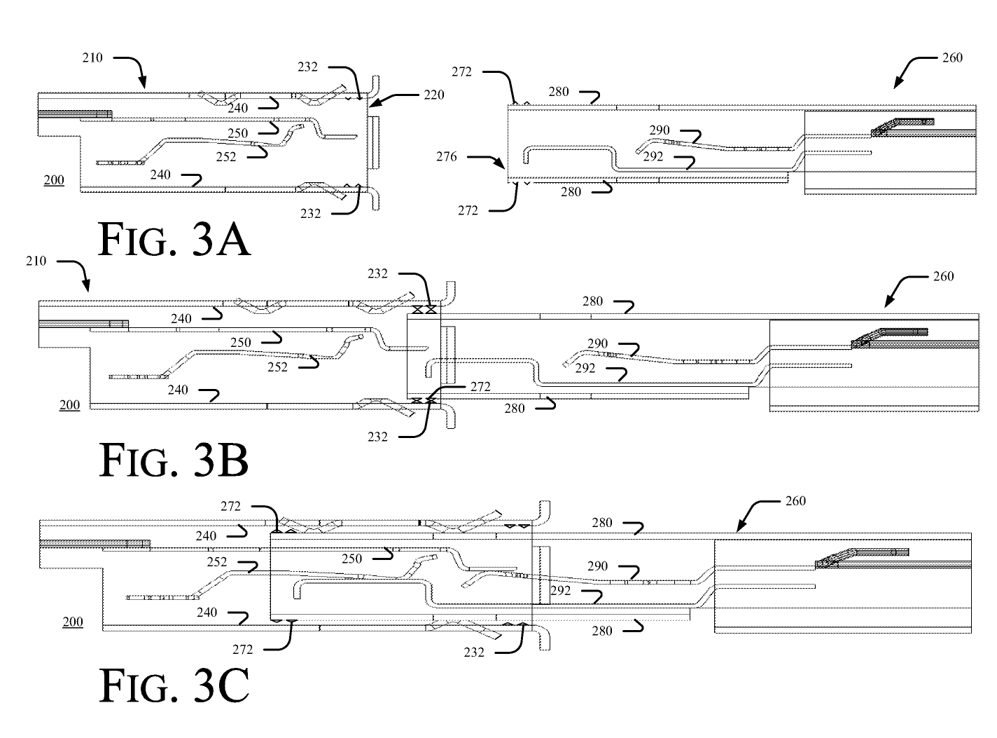

One example of a connector for an electrical device adapted to implement electrostatic discharge will be described with reference to FIGS. 2 and 3A-3C. While the connector depicted in FIGS. 2 and 3A-3C is a USB connector, one skilled in the art will recognized that the principles described herein are not limited to USB connectors, but are equally applicable to other connectors, e.g., audiovisual (AV) connectors or Ethernet connectors.

Referring to FIGS. 2 and 3A-3C, in one example an electrical connector 200 comprises a receptacle 210 comprising an opening 220 at a distal end to receive a plug 260 and an electrostatic conductor assembly 230 positioned proximate the opening 220 in the receptacle 210. In some examples the electrostatic conductor assembly 230 is coupled to a dedicated electrical discharge path 240 (FIGS. 3A-3C) which is configured to conduct electrical charges away from the at least one data connector 250/252 in the receptacle 210.

In the case of a USB connector as depicted in FIGS. 2 and 3A-3C, the receptacle 210 comprises a housing 212 which includes multiple interior surfaces 214 and which defines an opening 220 adapted to receive a plug 260. Similarly, plug 260 comprises a housing 262 which includes multiple exterior surfaces 264 and which defines an opening 276 (FIGS. 3A-3C).

The housing 212 encloses at least one data connector 250/252, and in the case of a USB connector comprises a plurality of data connectors 250/252. Similarly, the plug 260 includes at least one data connector 290/292, and in the case of a USB connector a plurality of data connectors 290/292. Further the opening 276 of the plug 260 is configured to receive the plurality of data connectors 250/252 in the receptacle 210 when the plug 260 in inserted into the receptacle 210, such that the plurality of data connectors 250/252 in the receptacle establish a data connection with the plurality of data connectors 290/292 in the plug 260.

In accordance with examples described herein, the receptacle 210 is provided with an electrostatic conductor assembly 230 positioned proximate the opening 220 in the receptacle. In the example depicted in FIGS. 2 and 3A-3C the electrostatic conductor assembly 230 comprises an array of conductive pins 232 positioned on interior surfaces 214 of the receptacle 210. The array of conductive pins 232 is positioned closer to the opening 220 of the plug than the data connectors 250/252. The conductive pins 232 are coupled to a dedicated discharge path 240 which is configured to conduct electrical charges away from the data connectors 250/252.

Similarly, the plug 260 comprises an electrostatic conductor assembly 270 positioned proximate the opening 276 in the plug 260. The electrostatic conductor assembly 270 comprises an array of conductive pins 272 positioned on exterior surfaces 264 of the plug 260. The array of conductive pins 272 is positioned closer to the opening 276 of the plug 260 than the data connectors 290/292. The conductive pins 272 are coupled to a dedicated discharge path 280 which is configured to conduct electrical charges away from the data connectors 290/292.

In some examples the conductive pins 232 and 272 are formed in the shape of at least one of a cone, a frustocone, or a dome to provide a shape which facilitate electrostatic discharge. However in other examples the respective electrostatic conductor assemblies 230, 270 may be formed as a continuous line of conductive material (e.g., a metallic strip or the like).

Operation of the connector 200 will be explained with reference to FIGS. 3A-3C. In the example depicted in FIG. 3A the plug 260 is disengaged from the receptacle 210. In use, a human hand or other mechanism inserts the plug 260 into the receptacle 210. Referring to FIG. 3B, at the inception of the engagement between receptacle 210 and plug 260 the conductive pins 232, 272 of the respective electrostatic discharge assemblies 230, 270 are brought into close proximity or into direct physical contact, which allows for electrical contact between the conductive pins 232, 272 of the respective electrostatic discharge assemblies 230, 270 before electrical contact is established between the respective data connectors 250/252, 290/292. Thus, any static electricity which may have accumulated on the plug 260 may be discharged via the dedicated discharge path(s) 240, 280, rather than via the respective data connectors 250/252, 290/292. FIG. 3C depicts the plug 260 inserted completely into receptacle 210.

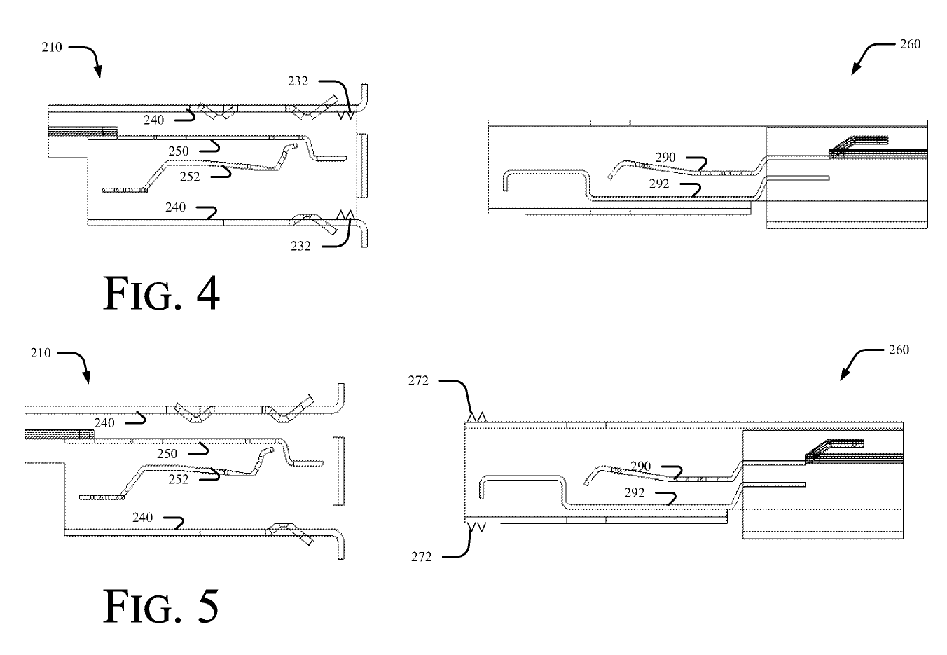

FIG. 4 is a schematic illustration of an alternate connector 200 in accordance with examples described herein. In the example depicted in FIG. 4, the electrostatic discharge assembly 230 comprises conductive pins 232 as described with reference to the examples of FIGS. 2 and 3A-3C, but the electrostatic discharge assembly 270 on the plug 260 is planar rather than pointed. The remaining components of the connector 200 may be embodied substantially as described with reference to the examples of FIGS. 2 and 3A-3C.

FIG. 5 is a schematic illustration of an alternate connector 200 in accordance with examples described herein. In the example depicted in FIG. 4, the electrostatic discharge assembly 270 comprises conductive pins 272 as described with reference to the examples of FIGS. 2 and 3A-3C, but the electrostatic discharge assembly 230 on the receptacle 210 is planar rather than pointed. The remaining components of the connector 200 may be embodied substantially as described with reference to the examples of FIGS. 2 and 3A-3C.

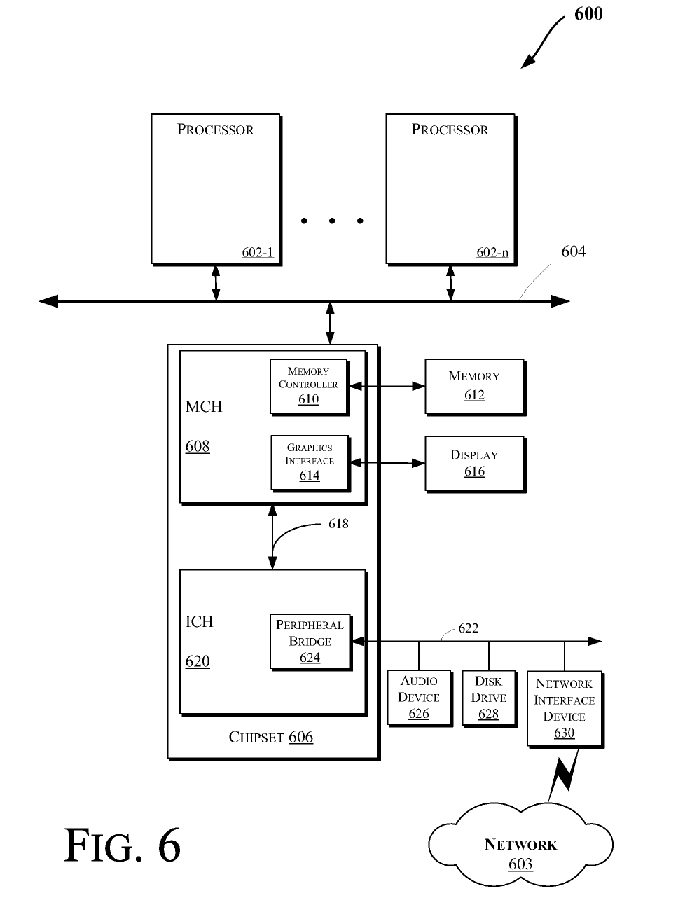

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 122 of FIG. 1.

A chipset 606 may also communicate with the interconnection network 604. The chipset 606 may include a memory control hub (MCH) 608. The MCH 608 may include a memory controller 610 that communicates with a memory 612 (which may be the same or similar to the memory 140 of FIG. 1). The memory 612 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

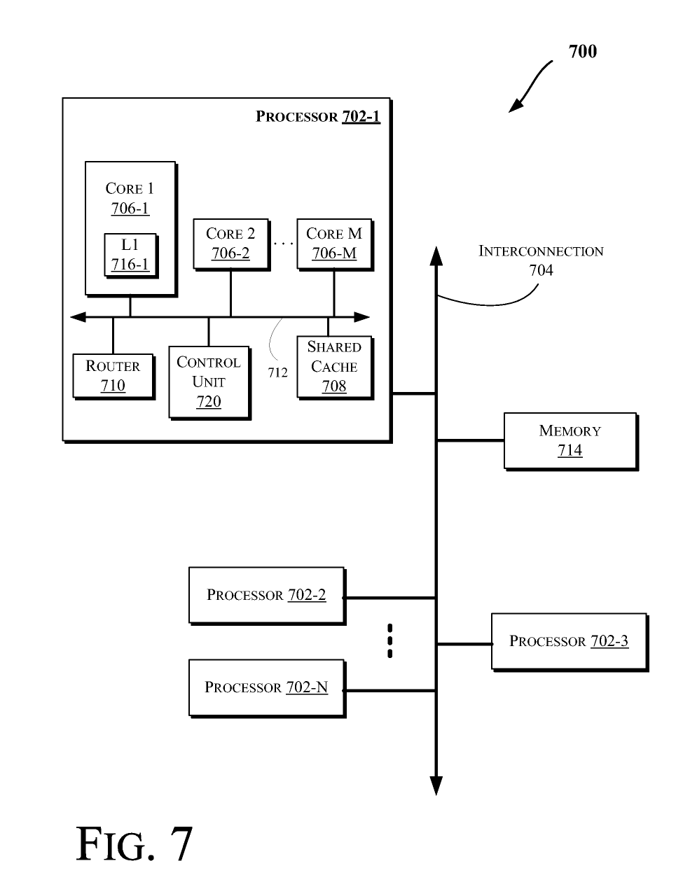

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 1.

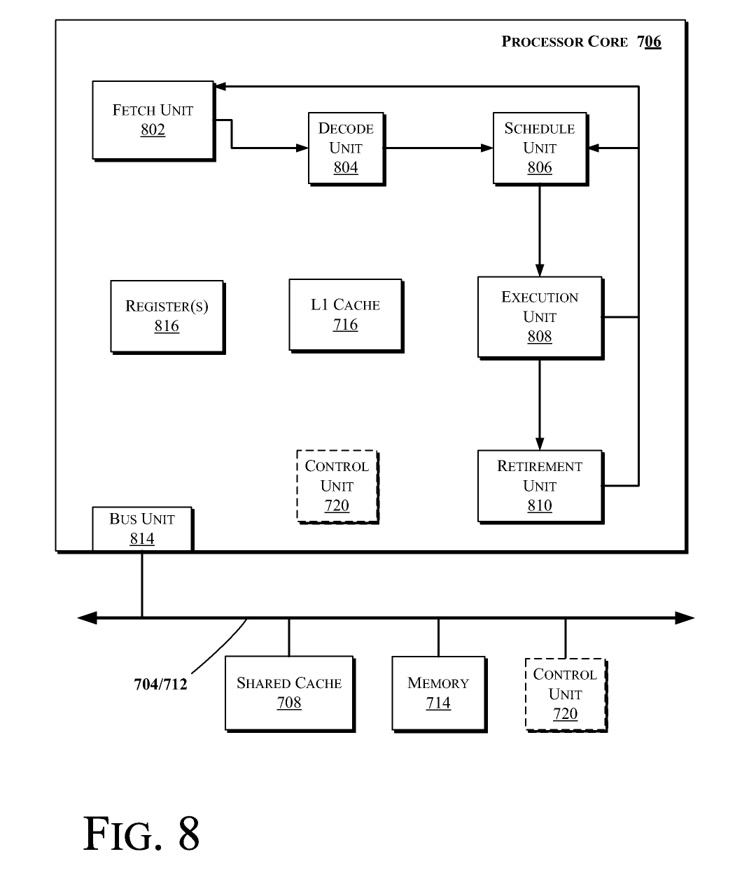

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 712 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 814 to enable communication between components of the processor core 706 and other components (such as the components discussed with reference to FIG. 8) via one or more buses (e.g., buses 704 and/or 712). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 712, in various examples the control unit 720 may be located elsewhere such as inside the core 706, coupled to the core via bus 704, etc.

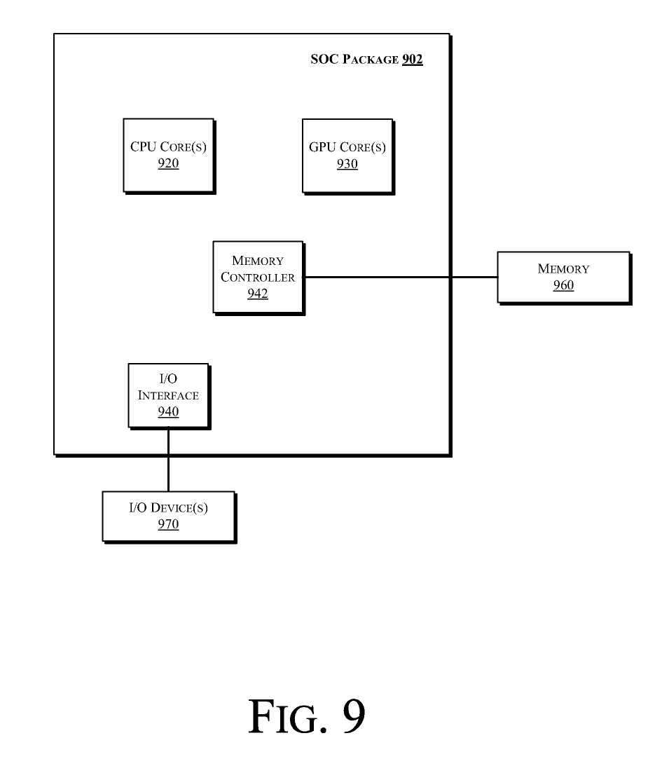

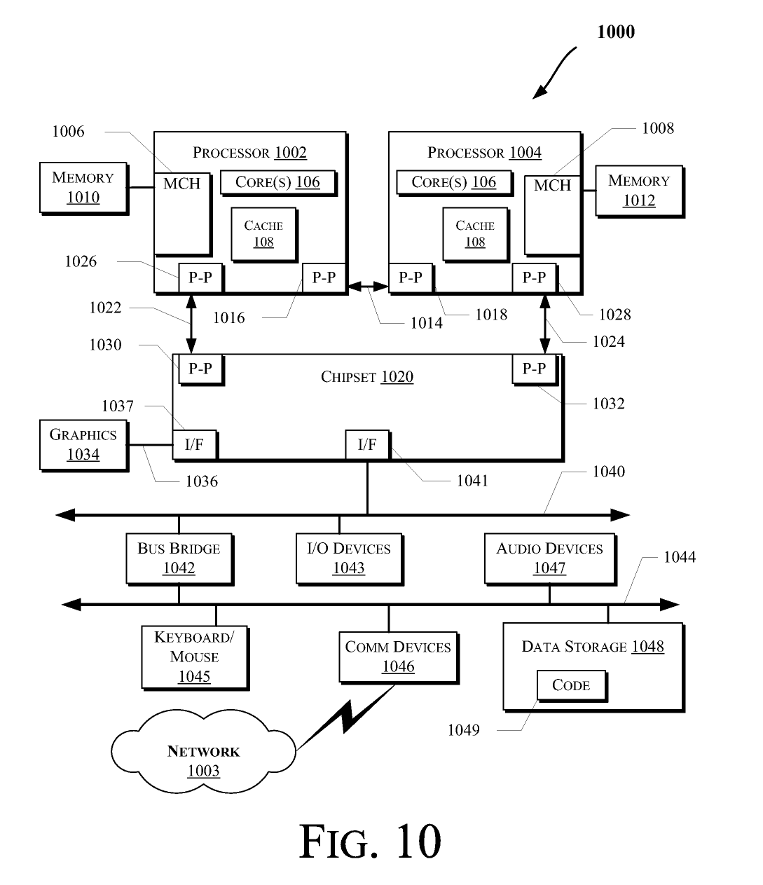

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1042 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further examples.

Example 1 is an electronic device comprising a housing, a receptacle in the housing comprising an opening at a distal end to receive a plug and an electrostatic conductor assembly positioned proximate the opening in the receptacle, wherein the electrostatic conductor assembly is coupled to a dedicated electrical discharge path.

In Example 2, the subject matter of Example 1 can optionally include an arrangement in which the receptacle comprises at least one of a power receptacle, a universal serial bus (USB) receptacle, an audio/visual (AV) receptacle, or an Ethernet receptacle.

In Example 3, the subject matter of any one of Examples 1-2 can optionally include an arrangement in which the electrostatic conductor assembly comprises an array of conductive pins positioned on an interior surface of the receptacle.

In Example 4, the subject matter of any one of Examples 1-3 can optionally include an arrangement in which the electrostatic conductor assembly comprises an array of conductive pins positioned on multiple interior surfaces of the receptacle.

In Example 5, the subject matter of any one of Examples 1-4 can optionally include an arrangement in which the conductive pins are formed in the shape of at least one of a cone, a frustocone, or a dome.

In Example 6, the subject matter of any one of Examples 1-5 can optionally include an arrangement in which the receptacle comprises at least one data connector and the array of conductive pins is positioned closer to the opening than the at least one data connector.

In Example 7, the subject matter of any one of Examples 1-6 can optionally include an arrangement in which the dedicated discharge path is configured to conduct electrical charges away from the at least one data connector.

Example 8 is a component for an electronic device comprising an input/output interface, a receptacle coupled to the input/output interface and comprising an opening at a distal end to receive a plug and an electrostatic conductor assembly positioned proximate the opening in the receptacle, wherein the electrostatic conductor assembly is coupled to a dedicated electrical discharge path.

In Example 9, the subject matter of Example 8 can optionally include an arrangement in which the receptacle comprises at least one of a power receptacle, a universal serial bus (USB) receptacle, an audio/visual (AV) receptacle, or an Ethernet receptacle.

In Example 10, the subject matter of any one of Examples 8-9 can optionally include an arrangement in which the electrostatic conductor assembly comprises an array of conductive pins positioned on an interior surface of the receptacle.

In Example 11, the subject matter of any one of Examples 8-10 can optionally include an arrangement in which the electrostatic conductor assembly comprises an array of conductive pins positioned on multiple interior surfaces of the receptacle.

In Example 12, the subject matter of any one of Examples 8-11 can optionally include an arrangement in which the conductive pins are formed in the shape of at least one of a cone, a frustocone, or a dome.

In Example 13, the subject matter of any one of Examples 8-12 can optionally include an arrangement in which the receptacle comprises at least one data connector and the array of conductive pins is positioned closer to the opening than the at least one data connector.

In Example 14, the subject matter of any one of Examples 8-13 can optionally include an arrangement in which the dedicated discharge path is configured to conduct electrical charges away from the at least one data connector.

Example 15 is an electrical connector, comprising a receptacle comprising an opening at a distal end to receive a plug and an electrostatic conductor assembly positioned proximate the opening in the receptacle, wherein the electrostatic conductor assembly is coupled to a dedicated electrical discharge path.

In Example 16, the subject matter of Example 15 can optionally include an arrangement in which the receptacle comprises at least one of a power receptacle, a universal serial bus (USB) receptacle, an audio/visual (AV) receptacle, or an Ethernet receptacle.

In Example 17, the subject matter of any one of Examples 15-16 can optionally include an arrangement in which the electrostatic conductor assembly comprises an array of conductive pins positioned on an interior surface of the receptacle.

In Example 18, the subject matter of any one of Examples 15-17 can optionally include an arrangement in which the electrostatic conductor assembly comprises an array of conductive pins positioned on multiple interior surfaces of the receptacle.

In Example 19, the subject matter of any one of Examples 15-18 can optionally include an arrangement in which the conductive pins are formed in the shape of at least one of a cone, a frustocone, or a dome.

In Example 20, the subject matter of any one of Examples 15-19 can optionally include an arrangement in which the receptacle comprises at least one data connector and the array of conductive pins is positioned closer to the opening than the at least one data connector.

In Example 21, the subject matter of any one of Examples 15-20 can optionally include an arrangement in which the dedicated discharge path is configured to conduct electrical charges away from the at least one data connector.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

1. An electronic device, comprising:
a housing;
a receptacle in the housing comprising an opening at a distal end to receive a plug; and
an electrostatic conductor assembly positioned proximate the opening in the receptacle, wherein the electrostatic conductor assembly comprises an array of conductive pins positioned on an interior surface of the receptacle and coupled to a dedicated electrical discharge path, such that static electricity which my have accumulated on the plug may be discharged via the dedicated discharge path.

2. The electronic device of claim 1, wherein the receptacle comprises at least one of a power receptacle, a universal serial bus (USB) receptacle, an audio/visual (AV) receptacle, or an Ethernet receptacle.

3. (canceled)

4. The electronic device of claim 1, wherein the electrostatic conductor assembly comprises an array of conductive pins positioned on multiple interior surfaces of the receptacle.

5. The electronic device of claim 1, wherein the conductive pins are formed in the shape of at least one of:
a cone;
a frustocone; or
a dome.

6. The electronic device of claim 1, wherein:
the receptacle comprises at least one data connector; and
the array of conductive pins is positioned closer to the opening than the at least one data connector.

7. The electronic device of claim 6, wherein:
the dedicated discharge path is configured to conduct electrical charges away from the at least one data connector.

8. A component for an electronic device, comprising:
an input/output interface;
a receptacle coupled to the input/output interface and comprising an opening at a distal end to receive a plug; and
an electrostatic conductor assembly positioned proximate the opening in the receptacle, wherein the electrostatic conductor assembly comprises an array of conductive pins positioned on an interior surface of the receptacle and coupled to a dedicated electrical discharge path, such that static electricity which my have accumulated on the plug may be discharged via the dedicated discharge path.

9. The component of claim 8, wherein the receptacle comprises at least one of a power receptacle, a universal serial bus (USB) receptacle, an audio/visual (AV) receptacle, or an Ethernet receptacle.

10. (canceled)

11. The component of claim 8, wherein the electrostatic conductor assembly comprises an array of conductive pins positioned on multiple interior surfaces of the receptacle.

12. The component of claim 8, wherein the conductive pins are formed in the shape of at least one of:
a cone;
a frustocone; or
a dome.

13. The component of claim 8, wherein:
the receptacle comprises at least one data connector; and
the array of conductive pins is positioned closer to the opening than the at least one data connector.

14. The component of claim 13, wherein:
the dedicated discharge path is configured to conduct electrical charges away from the at least one data connector.

15. An electrical connector, comprising:
a receptacle comprising an opening at a distal end to receive a plug; and
an electrostatic conductor assembly positioned proximate the opening in the receptacle, wherein the electrostatic conductor assembly comprises an array of conductive pins positioned on an interior surface of the receptacle and coupled to a dedicated electrical discharge path, such that static electricity which my have accumulated on the plug may be discharged via the dedicated discharge path.

16. The electrical connector of claim 15, wherein the receptacle comprises at least one of a power receptacle, a universal serial bus (USB) receptacle, an audio/visual (AV) receptacle, or an Ethernet receptacle

17. (canceled)

18. The electrical connector of claim 15, wherein the electrostatic conductor assembly comprises an array of conductive pins positioned on multiple interior surfaces of the receptacle.

19. The electrical connector of claim 15, wherein the conductive pins are formed in the shape of at least one of:
a cone;
a frustocone; or
a dome.

20. The electrical connector of claim 15, wherein:
the receptacle comprises at least one data connector; and
the array of conductive pins is positioned closer to the opening than the at least one data connector.

21. The electrical connector of claim 20, wherein:
the dedicated discharge path is configured to conduct electrical charges away from the at least one data connector.
